(19) United States
(12) Patent Application Publication
(10) Pub. No.: US 2008/0240482 A1
(43) Pub. Date: Oct. 2, 2008

(54) Arrangement For Optimizing the Frequency Response of an Electro-Acoustic Transducer

(75) Inventors: Gholamali Haddad, Vienna (AT); Ernst Ruberl, Guntramsdorf (AT); Carl Poldy, Vienna (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/092,629

(22) PCT Filed: Nov. 6, 2006
(86) PCT No.: PCT/IB06/54124

§ 371 Date: May 5, 2008

(30) Foreign Application Priority Data
Nov. 9, 2005 (EP) 05110528.6

(51) Int. Cl. H04R 1/20

(52) U.S. Cl. 381/337

(57) ABSTRACT

An arrangement for optimizing the frequency response of an electro-acoustic transducer (10), comprising the electro-acoustic transducer (10) and a damping element (12) arranged behind the sound emanating or receiving side of a membrane (14) of the electro-acoustic transducer (10), wherein an air gap (16) is provided between the damping element (12, 13) and the membrane (14), which air gap (16) is sufficiently small for intimately acoustically coupling the membrane (14) with the damping element (12, 13), wherein the damping element (12, 13) is adapted to dampen an air flow created by the membrane (14) when moving.

### FIELD OF THE INVENTION

The invention relates to an arrangement for optimizing the frequency response of an electro-acoustic transducer.

The invention further relates to a loudspeaker or microphone.

The invention finally relates to a loudspeaker cabinet, especially the housing of small multi-media devices, e.g. mobile (i.e. cell) phones.

### BACKGROUND OF THE INVENTION

Membranes of electro-acoustic transducers such as loudspeakers or microphones have one or more characteristic inherent vibrations or eigenvibrations, also called “modes”, which influence the transducer frequency response. In particular, such modes cause undesired anomalies (peaks, dips and points of inversion) in the frequency response. However, a flat frequency response is desired in order to achieve an authentic sound reproduction. Especially, flat membranes, being formed from more or less rigid plates, are sensitive to modes, but also other membranes, such as cone-shaped membranes, as well as soft non-rigid membranes, are prone to the occurrence of modes. Thus, it is important to restrict the influence of modes on the frequency response in order to achieve an authentic sound reproduction.

One known method of reducing the influence of modes is to dampen the membrane with absorbent material, for example glass wool. The absorbent material is brought into close contact with the membrane in order to obtain an optimal absorbing effect. U.S. Pat. No. 4,276,452 describes an electro-acoustic transducer in which inherent vibrations of the membrane are efficiently suppressed by absorbent material, which contacts the entire surface of the membrane uniformly. One disadvantage of the disclosed absorbing method is that it cannot be applied to existing electro-acoustic transducers since it requires a reconstruction of an electro-acoustic transducer, particularly of its membrane. Thus, this is an expensive method of reducing the influence of modes on the frequency response of an electro-acoustic transducer.

### OBJECT AND SUMMARY OF THE INVENTION

It is an object of the invention to provide an arrangement of the type defined in the opening paragraph, a loudspeaker and a microphone of the type defined in the second paragraph, and a loudspeaker cabinet of the type defined in the third paragraph, in which the disadvantage defined above is avoided.

In order to achieve the object defined above, an arrangement for optimizing the frequency response of an electro-acoustic transducer is presented, comprising the electro-acoustic transducer and a damping element arranged behind the sound emanating or receiving side of a membrane of the electro-acoustic transducer, wherein an air gap is provided between the damping element and the membrane, which air gap is sufficiently small for rigidly acoustically coupling the membrane with the damping element, wherein the damping element is adapted to dampen an air flow created by the membrane when moving.

In order to achieve the object defined above, furthermore a loudspeaker or a microphone comprises an arrangement for optimizing the frequency response of an electro-acoustic transducer according to the invention.

In order to achieve the object defined above, finally a loudspeaker cabinet comprises speakers and damping elements as parts of an arrangement according to the present invention. The invention is also applicable to a housing of a mobile multimedia device, e.g. a mobile (i.e. cell) phone with one or more integrated loudspeakers and/or microphones.

The characteristic features according to the invention provide the advantage that the influence of characteristic inherent vibrations or eigenvibrations, i.e. the modes of the membrane of the electro-acoustic transducer, on the frequency response may be efficiently reduced by the damping element or, more precisely said, by acoustically coupling the membrane and the damping element as rigidly as possible in order to reduce characteristic inherent vibrations or eigenvibrations. The word “rigid” and the term “rigid acoustic coupling” as well as the expression “intimate acoustic coupling” used in this patent, all mean that essentially the complete air masses moved by the membrane flow through the damping element and merely minor air streams bypass the damping element. It should be emphasized that “rigid acoustic coupling” does not mean a mechanical coupling of the damping element and the membrane, as known from U.S. Pat. No. 4,276,452. In particular, the frequency response of the electro-acoustic transducer can be improved in that it better approaches a flat frequency response with no significant anomalies through the measures according to the invention. This can make the sound reproduction of the transducer more authentic than without the measures of the invention. The damping element according to the invention causes damping of the air moved between the damping element and the membrane of the transducer by the membrane displacements. Thus, the damping element causes conversion of the kinetic energy of the air flow or the sound energy into thermal energy and, therefore, absorption of sound generated by the membrane of the electro-acoustic transducer. The air damping may decrease the Q (quality factor) of one or more anomalies in the frequency response. According to the invention, not only characteristic vibrations in the lower acoustic frequency range are reduced, but also characteristic vibrations in the higher acoustic frequency range may be efficiently reduced. The invention may be applied to any electro-acoustic transducer such as a speaker or a microphone, or to a loudspeaker cabinet, comprising one or more speakers. Furthermore, the invention may be applied to electro-acoustic transducers with plane-plate, cone- or dome-shaped membranes. In contrast to the transducer disclosed in U.S. Pat. No. 4,276,452, the invention is a simpler construction which requires no reconstruction of a transducer and may be applied to existing transducers.

It should be observed that putting an absorbent material into the interior of a loudspeaker cabinet or its sound channels in order to dampen standing waves in the air cavity is known. These waves may occur at certain frequencies depending on the geometrical dimensions of the cabinet due to reflections of the sound waves at the hard inner walls of the cabinet (i.e. the modes of the cabinet caused by oscillations of the air). However, according to the prior art the absorbent material has not been used to optimize the frequency response of the electro-acoustic transducer, that is to say to damp the modes of the transducer membrane (i.e. waves in a solid body) through use of damped air flows (i.e. waves in air) rigidly coupled to the membrane.

A further reduction in the influence of modes may be achieved if the damping element has dimensions such that its area facing the membrane is at least as large as the area of the membrane. This measure avoids air moved by the displacement of the membrane bypassing the damping element.

In order to avoid the occurrence of eigenvibrations of the damping element, it may be rigidly mounted behind the sound emanating or receiving side of the membrane.

In order to achieve a highly efficient reduction in membrane eigenvibrations, the air gap may be as small as possible since volume in the equivalent acoustic circuit means an acoustic compliance, which represents an imaginary part of the acoustic impedance of the electro-acoustic transducer and which should be as small as possible. A lower limit of the air gap size is determined by the maximum or largest possible displacement of the membrane. Thus, it is preferred to size the air gap slightly larger than the largest possible displacement of the membrane. Since this is a slit, the damping resistance R (see FIG. 4) for sound is inversely proportional to the third power of d (d is the smallest significant dimension perpendicular to the air flow) of the gap between the membrane and an acoustically hard wall. Thus, the desired damping may be achieved by determining the air gap between the damping element and the membrane due to this relationship.

According to one embodiment of the invention, the damping element may comprise a plurality of channels distributed over the element and with openings on the surface of the element in order to receive air moved by the membrane. The function of these acoustic channels is to receive sound energy. In the channels the received sound energy is converted into thermal energy mainly by viscosity friction between the air flowing in the channels and the walls of the channels.

The channels may be slit-, hole- or amorphous-shaped.

In order to achieve efficient conversion of the received sound energy into thermal energy, the channels may be formed such that they go through the damping element so that sound entering a channel on one side of the damping element may leave the damping element on another side.

Alternatively, the channels may be closed. Especially if the channels are closed, their depth may be selected such that kinetic energy of the entering air flow generated by the membrane is almost completely converted into thermal energy within the damping element.

In addition to holes and slits, the damping element may also comprise an amorphous porous material in order to absorb the sound from the electro-acoustic transducer.

As a rule of thumb, the channels or pores should have a diameter less than about 0.1 millimeter since in this case the desired damping for efficient sound absorption has an effect in a frequency range up to 2.5 kHz. See FIG. 4. Most of the different types of membrane have their eigenvibrations in this frequency range. In general, the upper frequency up to which the damping has an effect increases as the diameter of the channels or pores decreases. Thus, the damping element or its effect on the eigenvibrations of a membrane may be adapted by selecting the diameter of the channels or pores to a certain electro-acoustic transducer and its membrane. By providing channels or pores of different diameter respectively different acoustic properties at the same time, different modes of the membrane can be damped.

Furthermore, it is preferred that the damping element is shaped like a plate. A plate may be produced easily and can be applied to different membrane shapes. A damping plate may be most suitable for an electro-acoustic transducer with a plane membrane since the air gap between the damping plate and the membrane may be accurately adjusted.

Preferably, the thickness of the plate is selected such that essentially no reflections of sound received by the damping element occur on its outer limiting surfaces.

According to a further embodiment of the invention, the damping element may comprise several layers of damping material arranged one behind the other. Thus, the sound absorbing effects of different materials may be combined in order to achieve a highly efficient sound absorption.

According to further embodiments, the transducers are selected from the piezoelectric type or the electromagnetic type or the iso-dynamic type or any other electro-dynamic type. The aspects defined above and further aspects of the invention are apparent from the exemplary embodiment to be described hereinafter and are explained with reference to this exemplary embodiment.

### BRIEF DESCRIPTION OF THE DRAWINGS

The invention will be described in more detail hereinafter with reference to an exemplary embodiment. However, the invention is not limited to this exemplary embodiment.

FIG. 1 shows a first embodiment of the arrangement according to the invention for optimizing the frequency response of an electro-acoustic transducer as an “open” arrangement.

FIG. 2 shows a second embodiment of the arrangement according to the invention for optimizing the frequency response of an electro-acoustic transducer as a “closed” arrangement.

FIG. 3 shows different embodiments of the openings of channels of the damping element according to the invention.

FIG. 4 shows basic acoustic equations as well as acoustic elements and their electrical equivalent circuits.

### DESCRIPTION OF EMBODIMENTS

Identical, similar, and functionally identical or similar elements can be denoted with the same reference numerals in the following description.

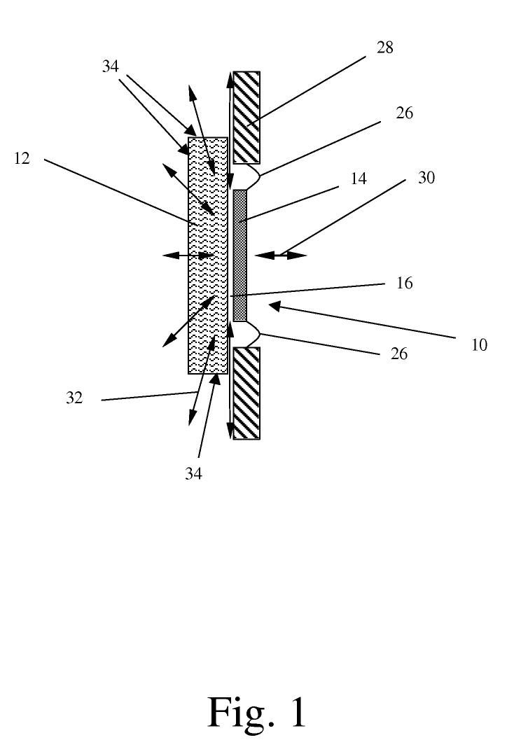

FIG. 1 shows an electro-acoustic transducer configured as a loudspeaker 10 with a plane membrane 14, for example a rigid plate, which is mounted in an opening of an acoustically “open” housing 28, for example a wall with an opening for the loudspeaker 10. The membrane 14 of the loudspeaker 10 is mounted at the housing 28 by a suspension 26, which is flexible such that the membrane 14 may oscillate or vibrate unimpeded.

A plate-shaped damping element 12 comprising a porous material is rigidly mounted immediately behind the sound emanating side of the membrane 14 such that only a small air gap 16 is provided between the membrane 14 and the damping element 12. The air gap 16 is sized so small that the membrane 14 is acoustically coupled to the damping element 12 as rigidly as possible without touching it, in order to optimally reduce the influence of any eigenvibrations of the membrane 14 on the frequency response of the transducer 10.

Typically, the air gap 16 is sized a little larger than the largest possible displacement 30 of the membrane 14 in order to avoid the membrane 14 being able to bump against the damping element 12 which could result in distortions. The air gap 16 may not be sized so large that an essential part of the air flow 32 generated by vibrations of the membrane 14 can bypass the damping element 12 so that the effect of the damping element 12 is significantly reduced.

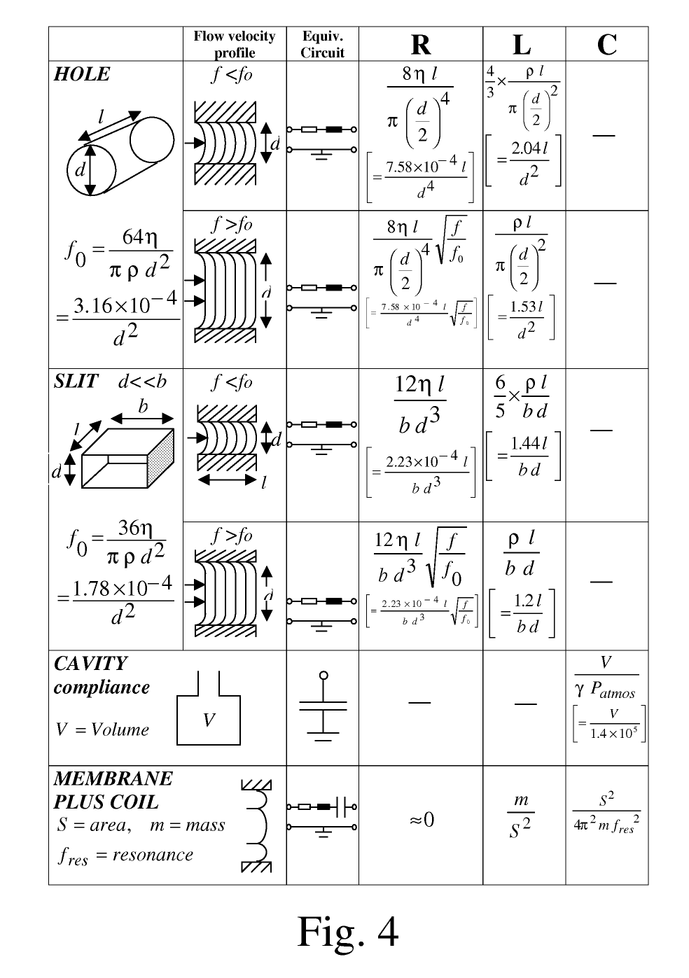

The degree of sound absorption depends on the thickness of the damping element 12 according to the equations at the top of FIG. 4. As can be seen, the dimensions of the damping element 12 are selected such that they are larger than the dimensions of the membrane 14 in order to avoid an essential part of air flow generated by the membrane 14 being able to bypass the damping element 12. It should be noted that the shape of the damping element is adapted to the shape of the membrane, i.e., if the membrane is cone- or dome-shaped the damping element 12 should also be cone- or dome-shaped in order to provide the small air gap 16 with an almost constant size over the entire area of membrane 14.

In FIG. 1 moreover a small slit is provided between the damping element 12 and the housing 28, which is also provided for damping. Such an arrangement may be useful if it is not possible to place a damping element 12 with the desired acoustic properties behind the membrane 14 (e.g. it is conceivable that due to limited space only a thin, rigid, airtight plate may be placed behind the membrane). In this case, said small slit provides the damping of the air flows as required for the inventive effect. In another case, a (homogeneous) damping element 12 as well as said slit are chosen in such a way that two different low-pass cut-off frequencies (see also FIG. 4, hole and slit) are defined and consequently higher order modes of the membrane 14 are damped with different degrees. Since the choices of cut-off frequencies may be made quite independently from another, a designer can more or less freely damp higher order modes. However, the slit shown in FIG. 1 is not a mandatory feature of the invention. Instead the connection between damping element 12 and the housing 28 may be airtight too.

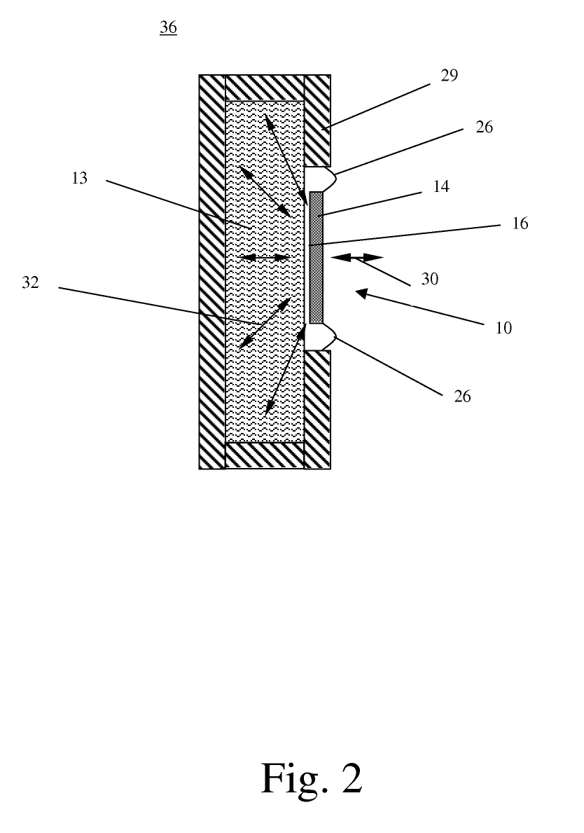

FIG. 2 shows a loudspeaker cabinet or box 36 comprising an acoustically closed housing 29 with an opening in which a loudspeaker 10 with a plane membrane 14, for example a rigid plate, is mounted. As with the embodiment of FIG. 1, the membrane 14 of the loudspeaker 10 is mounted at the housing 29 by a suspension 26 which is flexible such that the membrane 14 may oscillate or vibrate unimpeded.

In contrast to FIG. 1, the acoustically closed housing 29 is nearly completely filled with porous material as a damping element 13. However, as with the embodiment of FIG. 1 a small air gap 16 is formed behind the sound emanating side of the membrane 14 in order to acoustically couple the membrane 14 with the damping element 13 as rigidly as possible. The same rules as described in connection with FIG. 1 apply for the size of the air gap 16. However, it should be noted that the thickness of the layer of porous material should be so large that sound received from the membrane 14 is well absorbed within the porous material. Thus, it is important that only a minor portion of sound, or better none at all, running through the porous material is reflected within the housing 29. As a rule of thumb, the thickness of the damping element 13 or the porous material is sufficient for the purpose of the invention if essentially no reflections occur on the outer limiting sides of the damping element 34 or the inner sides of the housing 29. Then sound running through the damping element 13 is well converted into thermal energy and, therefore, absorbed.

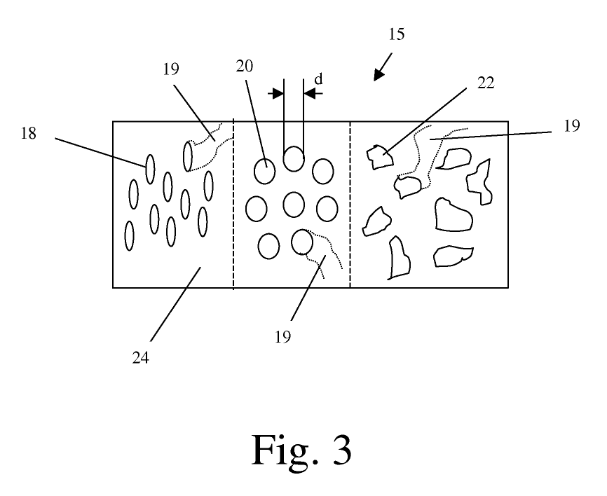

FIG. 3 shows the surface 24 of a damping element 15. In particular, it shows in detail three different types of preferred material for a damping element 15 according to the invention. On the left, the surface 24 of a damping element 15 with a material comprising channels 19 with slit-shaped openings 18 is shown. The slit-shaped openings 18 are nearly equally distributed over the surface 24 in order to receive sound. In the middle, the surface 24 of a damping element 15 with a material comprising channels 19 with hole-shaped openings 20 is shown. The hole-shaped openings 20 have a diameter d. On the right, the surface 24 of a damping element 15 with a material comprising channels 19 with amorphous openings 22 is shown.

Sound generated by an electro-acoustic transducer may enter the openings 18, 20, or 22 and run into the channels 19, in which they are converted into thermal energy due to the air damping. In detail, frictional forces occur between the air flow running into a channel 19 and the surface of the channel, which cause an acoustic impedance in the air flow direction. The real part of the complex acoustic impedance is inversely proportional to the third power of the channel diameter d. The plurality of openings on the surface 24 may be considered as a parallel arrangement of several acoustic impedances of the single channels 19. Thus, a desired coefficient of friction may be achieved.

The invention has the advantage that the frequency response of an electro-acoustic transducer 10 may be optimized by reducing the influence of modes on the frequency response. This is achieved without requiring a reconstruction of the electro-acoustic transducer 10 with a damping element 12, 13, 15 acoustically coupled with the membrane 14 of the electro-acoustic transducer 10 as rigidly as possible. Thus, the Q factor of modes may be reduced significantly and the frequency response of the transducer made flatter. The invention may be implemented at low cost with various materials as described above. It may also be applied to electro-acoustic transducers with different membrane shapes such as cone-, dome-shaped or plane membranes. It may be advantageously applied to loudspeakers and microphones, in particular improving the frequency response in the higher frequency range.

FIG. 4 shows acoustic elements, their electrical equivalent circuits, and R, L, C values expressed in terms of mechanical dimensions: l, b, d [m], S[m²], V[m³] and frequency f [Hz]. Effective total length of a constriction in the flow direction is l. For a circular hole the total effective length l equals the geometrical length l₀ plus the end correction 0.85 d. The viscosity coefficient under normal conditions is η=1.86×10⁻⁵ kg/(ms). It is proportional to pressure and roughly proportional to absolute temperature [K]. Air density is ρ=1.2 kg/m³. Speed of sound c₀=340 m/s. Specific heat ratio γ=1.4 for air. Pₐₜₘₒₛ=10⁵ Pascal. The impedance analogy is used, where sound pressure [Pa] is equivalent to voltage [V], and volume velocity [m³/s] is equivalent to current [A]. The equivalences for L, R, and C are 1 H≡1 kg/m⁴, 1Ω≡1 kg/(m⁴s), 1 F≡1 m⁴s²/kg.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. An arrangement for optimizing the frequency response of an electro-acoustic transducer, comprising the electro-acoustic transducer and a damping element arranged behind the sound emanating or receiving side of a membrane of the electro-acoustic transducer, wherein an air gap is provided between the damping element and the membranes, which air gap is sufficiently small for rigidly acoustically coupling the membrane with the damping element, wherein the damping element is adapted to dampen an air flow created by the membrane when moving.

2. An arrangement as claimed in claim 1, wherein the damping element has dimensions such that its area facing the membrane is at least as large as the area of the membrane.

3. An arrangement as claimed in claim 1, wherein the damping element is rigidly mounted behind the sound emanating or receiving side of the membrane.

4. An arrangement as claimed in claim 1, wherein the air gap is sized larger than the largest possible displacement of the membrane.

5. An arrangement as claimed in claim 1, wherein the damping element comprises a plurality of channels distributed over the damping element and with openings on the surface of the damping element through which the air flows.

6. An arrangement as claimed in claim 5, wherein the channels are formed such that they penetrate the damping element.

7. An arrangement as claimed in claim 5, wherein the depth of the channels is selected such that the kinetic energy of the air flow entering the channels is suitably absorbed within the damping element.

8. An arrangement as claimed in claim 5, wherein the smallest effective dimension d perpendicular to the flow direction of the channels or pores is less than about 0.1 millimeter.

9. An arrangement as claimed in claim 1, wherein the thickness of the damping element is selected such that any reflections of sound occurring on its outer limiting surfaces are not essential to the damping function.

10. A loudspeaker or microphone comprising an arrangement as claimed in claim 1.

11. A loudspeaker cabinet comprising at least one loudspeaker as claimed in claim 10.

12. A housing of a mobile device with one or more integrated loudspeakers and/or microphones, arranged as claimed in claim 1.
